(19) United States
(12) Patent Application Publication
(10) Pub. No.: US 2001/0052838 A1
(43) Pub. Date: Dec. 20, 2001

(54) Adhesive resin composition and method of producing the same, chip coil component

(75) Inventors: Kenichi Hamanaka, Kyoto-fu (JP); Kunisaburo Tomono, Kyoto-fu (JP); Akihiko Kawakami, Kyoto-fu (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/854,767

(22) Filed: May 14, 2001

(30) Foreign Application Priority Data
May 15, 2000 (JP) 2000-142059

(51) Int. Cl. H01F 5/00

(52) U.S. Cl. 336/200

(57) ABSTRACT

An adhesive composition includes a mixture of a ferrite powder and a liquid matrix resin that contains at least one of (A) a polyamic acid and (B) a resin which has an imide bond, is capable of an addition reaction with an amine or capable of self-polymerization, and is capable of dissolving in an organic solvent. The adhesive composition uses a thermally stable polyimide resin and can contain a ferrite powder in a sufficiently high density as to form a satisfactorily closed magnetic circuit structure.

### BACKGROUND OF THE INVENTION

1. Field of the Invention

The present invention relates to an adhesive resin composition, particularly to an adhesive resin composition containing ferrite. The invention also relates to a chip coil component such as a choke coil or inductor using the adhesive resin composition.

2. Description of the Related Art

A conventional chip coil component such as a choke coil or inductor is produced in the following manner. Specifically, coil conductor patterns are formed on insulator sheets, and the sheets are laminated; the resulting laminate is sandwiched and bonded between ferrite substrates on the upper and lower sides with an adhesive to thereby seal the resulting laminate, and outer electrodes are formed on the ferrite substrates so as to electrically connect the outer electrodes to the coil conductor pattern.

However, the chip coil component having the above configuration has a magnetically open circuit structure, since it is only sealed by the adhesive on its side faces, whereas it is sealed by the ferrite substrates on its top and bottom faces. Accordingly, this chip coil component may exhibit a varied inductance or Q value affected by an outer magnetic field or may invite noise problems due to a current passing through the coil conductor pattern. When a plurality of coil conductor patterns are arranged in one component as in a choke coil array or inductor array, the coil conductor patterns are magnetically coupled with each other to thereby invite mutual interference.

As a possible solution to these problems, Japanese Unexamined Patent Application Publication No. 60-144365 proposes an adhesive of a thermosetting resin molding material comprising 5% to 80% by weight of a ferrite based on the total weight of the composition. This publication also discloses, as thermosetting resins for use in the composition, phenol resins, epoxy resins, unsaturated polyester resins, melamine resins, furan resins, polybutadiene resins, and polyimide resins.

Such conventional adhesive compositions have, however, the following disadvantages.

1. When, for example, a phenol resin, epoxy resin, unsaturated polyester resin, melamine resin, furan resin or polybutadiene resin is used as the thermosetting resin, the resulting adhesive cannot be applied to a product that is subjected to a process performed at high temperatures of 300° C. or higher such as a sputtering procedure, since these resins are insufficient in heat resistance.

2. When a polyimide resin is used as the thermosetting resin, the resulting adhesive is satisfactory in heat resistance but the polyimide resin is not dissolved in an organic solvent and is hardly melted even at high temperatures, and the adhesive cannot contain a ferrite in a high density.

### SUMMARY OF THE INVENTION

Accordingly, the present invention provides an adhesive composition that uses a thermally stable polyimide resin and can contain a ferrite powder in such a high density as to form a satisfactory closed magnetic circuit structure, to provide a method of producing the adhesive composition, and to provide a chip coil component having a closed magnetic circuit structure formed by the use of the adhesive composition.

Specifically, according to one aspect of the present invention, an adhesive resin composition includes a mixture of a liquid matrix resin and a ferrite powder, which liquid matrix resin contains at least one of the following ingredients (A) and (B):

(A) a polyamic acid; and

(B) a resin which has an imide bond, is capable of an addition reaction with an amine or capable of self-polymerization, and is capable of dissolving in an organic solvent.

In the adhesive resin composition, the liquid matrix resin preferably becomes a polyimide resin after curing.

Preferably, 200 to 1500 parts by weight of the ferrite powder is contained in the adhesive resin composition relative to 100 parts by weight of a resin ingredient in the liquid matrix resin.

This configuration can yield a thermally stable adhesive and can form a satisfactory closed magnetic circuit structure. Specifically, a sufficient amount of a ferrite powder can be contained into the adhesive by mixing the liquid matrix resin that becomes a polyimide resin after curing with the ferrite powder to thereby allow the adhesive itself to yield a sufficient closed magnetic circuit effect. Additionally, the resulting adhesive can withstand even processes at high temperature.

In the adhesive resin composition, the ferrite powder preferably has a mean grain size from 0.01 mm to 5 mm.

The use of this type of ferrite powder can yield an adhesive resin composition having satisfactory handling property, which can be applied even to a chip coil component of a small size.

In another aspect, the present invention provides a method of producing an adhesive resin composition, which includes the step of mixing a ferrite powder with a liquid matrix resin containing at least one of the following ingredients (A) and (B):

(A) a polyamic acid; and

(B) a resin which has an imide bond, is capable of an addition reaction with an amine or capable of self-polymerization, and is capable of dissolving in an organic solvent.

With this method, the resulting adhesive resin composition can contain a sufficient amount of a ferrite powder in a high density and can exhibit a satisfactory heat resistance after curing.

In the method of producing an adhesive resin composition, it is preferred to mix the ferrite powder with the liquid matrix resin while grinding the ferrite powder using a forced-agitating grinder with a grinding media.

This mixing technique can mix the ferrite powder with the liquid resin matrix while grinding the ferrite powder, and can greatly improve production efficiency as compared with a process which includes conventional grinding and mixing operations. Such a conventional process requires the steps of drying a ferrite powder which has been wet-milled in, for example, a ball mill; disintegrating the dried ferrite powder; mixing the ground ferrite powder with a liquid resin matrix using an agitator; and disintegrating the ferrite powder aggregated during the mixing operation with, for example, a three-roller mill. However, the use of the above forced-agitating grinder can realize pulverization (fine grinding) of the ferrite powder and mixing of the same with the liquid resin matrix in one machine, without the need of a series of facilities for the wet-grinding step, disintegration step, and disintegration step after mixing with the resin. Additionally, the mixing technique uses a grinding media and can mix the ferrite powder with the resin without reaggregation of a fine ferrite powder.

In addition and advantageously, the present invention provides a chip coil component which includes a coil unit having at least one coil conductor pattern; a pair of magnetic substrates sandwiching the coil unit; and an outer electrode being electrically connected with the coil conductor pattern. In the chip coil component, the coil unit is bonded to the magnetic substrates via the adhesive resin composition of the invention to allow the magnetic substrates and the adhesive resin composition to form a closed magnetic circuit structure.

This configuration can allow the magnetic substrates and the adhesive resin composition to cover the coil unit and form a closed magnetic circuit structure to thereby protect the coil unit from adverse effects due to an outside magnetic field or mutual interference in the coil unit.

Other features and advantages of the invention will be appreciated from the following description, wherein like references denote like elements and parts.

### BRIEF DESCRIPTION OF THE DRAWING(S)

FIG. 1 is an exploded perspective view showing a chip coil component according to one embodiment of the present invention;

FIG. 2 is a schematic perspective view showing the chip coil component of the present invention shown in FIG. 1;

FIG. 3 is a sectional view showing the chip coil component of the present invention shown in FIG. 1;

FIG. 4 is an exploded perspective view showing a chip coil component according to another embodiment of the present invention;

FIG. 5 is a schematic perspective view showing the chip coil component of the present invention shown in FIG. 4; and

FIG. 6 is a sectional view showing the chip coil component of the present invention shown in FIG. 4.

Other features and advantages of the present invention will become apparent from the following description of the invention which refers to the accompanying drawings.

### DETAILED DESCRIPTION OF EMBODIMENTS OF THE INVENTION

An adhesive resin composition of the present invention comprises a ferrite powder mixed in a liquid matrix resin that becomes a polyimide after curing.

Such resin ingredients for use in the liquid matrix resin that becomes a polyimide after curing (hereinafter referred to as “matrix resin ingredient”) include, for example, polyamic acids (or referred to as polyamide acid), and a compound which has an imide bond, is capable of an addition reaction with an amine or capable of self-polymerization, and is capable of dissolving in an organic solvent.

The polyamic acids are obtained by a reaction of a tetracarboxylic anhydride with a diamine. Such tetracarboxylic anhydrides include, but are not limited to, pyromellitic anhydride, biphenyltetracarboxylic anhydride, benzophenonetetracarboxylic anhydride, and ethylenetetracarboxylic anhydride; and such diamines include, for example, diaminodiphenyl ether, diaminodiphenyl sulfone, diaminodiphenylmethane, and aminobenzylamine. The combination of the tetracarboxylic anhydride ingredient with the diamine ingredient is not specifically limited. Such polyamic acids are polymers having an amide bonding a carboxyl group and is dissolved in some solvents. When the polyamic acids are heated, dehydration cyclic reaction occurs to yield polyimide.

The compound having an imide bond, being capable of an addition reaction with an amine or capable of self-polymerization, and being capable of dissolving in an organic solvent includes, but is not limited to, bismaleimide and bismaleimidamide. Such compounds are monomers of polyimide and are easy to be dissolved in some solvents. By heating the compounds, self-polymerization or polymerization with amine occurs to yield polyimide.

The ferrite powder is a compound of an iron oxide and an oxide of the other metals, and includes, but is not limited to, a Ni—Zn ferrite, Mn—Zn ferrite, and Mg—Zn ferrite. The ferrite powder preferably has a mean grain size from 0.01 mm to 5 mm. If the mean grain size of the ferrite powder is less than 0.01 mm, the mixture of the ferrite powder with the liquid matrix resin has an increased viscosity which deteriorates its handling properties as an adhesive. Additionally, the ferrite powder aggregates over time, and subsequently has a nonuniform grain size and has a decreased magnetic permeability. In contrast, if the mean grain size of the ferrite powder exceeds 5 mm, the ferrite powder becomes liable to sediment and disperses inhomogeneously. Additionally, when an adhesive containing such a ferrite powder is used for sealing of a coil conductor pattern formed by sputtering or by a thin film, the ferrite powder may damage the coil conductor pattern due to pressures during printing.

In the mixing operation of the ferrite powder with the matrix resin ingredient, the ferrite powder is contained at a high density, and the matrix resin ingredient therefore must be liquefied. The matrix resin ingredient may be liquefied by any of a process of heating and melting the matrix resin ingredient and a process of dissolving the matrix resin ingredient in an organic solvent.

In addition to the liquid matrix resin and the ferrite powder, the invented adhesive resin composition may further comprise a dispersing agent to modify the surface of the ferrite powder to thereby improve wettability with the matrix resin ingredient. Such dispersing agents include, for example, polyoxyethylene monoallylmethyl ether, maleic anhydride-styrene copolymer, polyoxyethylene laurylamine, and naphthalenesulfonic acid.

The proportion of the ferrite powder to the matrix resin ingredient is preferably 200 to 1500 parts by weight, and more preferably 400 to 1200 parts by weight, relative to 100 parts by weight of the matrix resin ingredient. If the proportion of the ferrite powder is less than 200 parts by weight relative to 100 parts by weight of the matrix resin ingredient, the magnetic permeability may be decreased. If it exceeds 1500 parts by weight relative to 100 parts by weight of the matrix resin ingredient, the resulting adhesive may have an increased viscosity to thereby deteriorate the handling property and to decrease the strength of the adhesive.

The forced-agitating grinder using a grinding media for use in the mixing operation of the liquid matrix resin and the ferrite powder is one that can grind the ferrite powder and concurrently mix the same with the liquid matrix resin, and includes, for example, a sand mill and attriter.

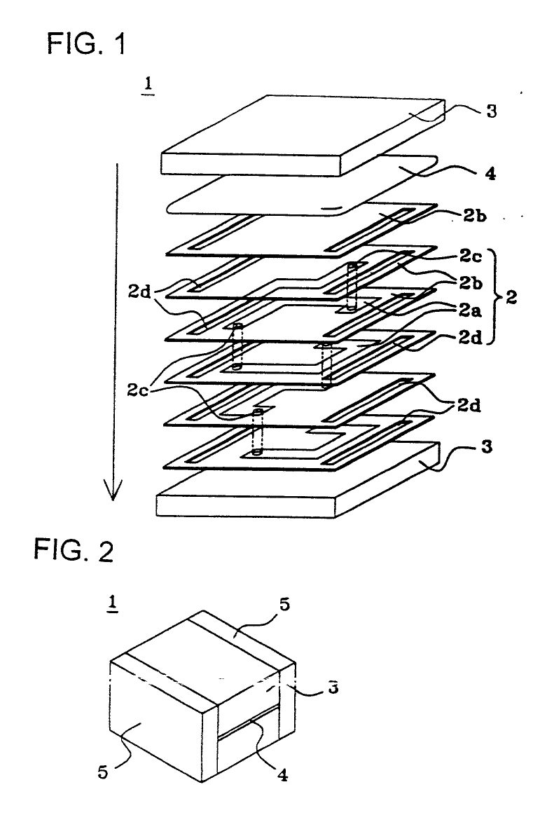

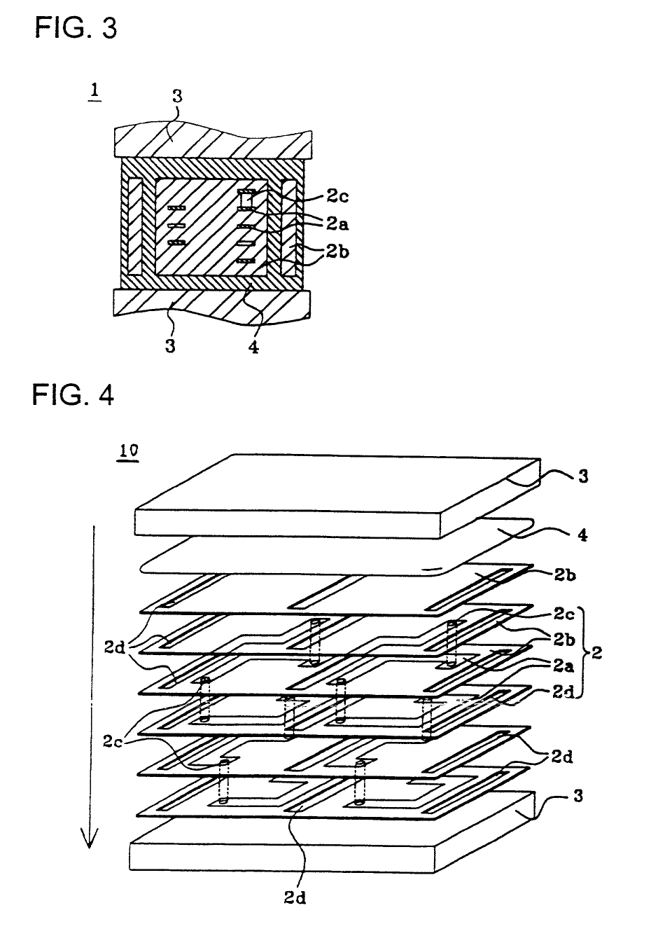

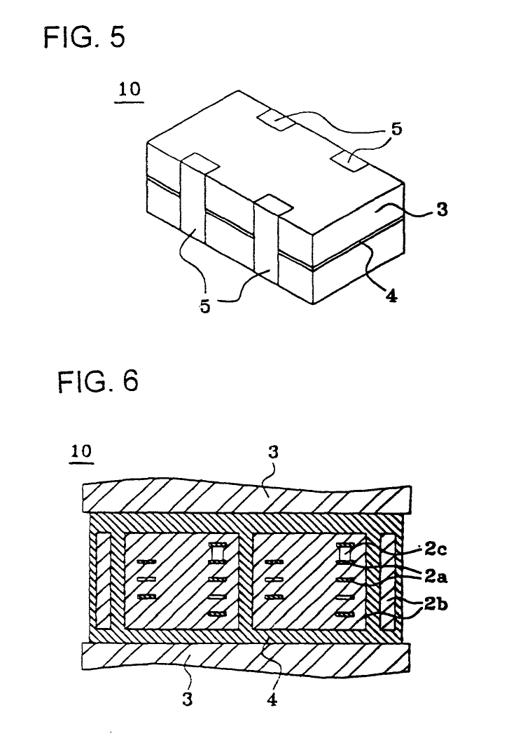

Next, a chip coil component according to the present invention will be illustrated below. FIG. 1 is an exploded perspective view showing a chip coil component as an embodiment of the present invention; FIG. 2 is a schematic perspective view showing the chip coil component shown in FIG. 1; FIG. 3 is a sectional view showing the chip coil component shown in FIG. 1; FIG. 4 is an exploded perspective view showing a chip coil component as another embodiment of the present invention; FIG. 5 is a schematic perspective view showing the chip coil component shown in FIG. 4; and FIG. 6 is a sectional view showing the chip coil component shown in FIG. 4.

As shown in FIGS. 1 and 2, chip coil component 1 of the present invention includes a coil part 2, ferrite substrates (magnetic substrates) 3 sandwiching coil unit 2 via an adhesive (adhesive composition) 4, and outer electrodes 5. Coil unit 2 is formed by laminating plural plies of insulating sheets 2b each having a coil conductor pattern 2a formed thereon, and electrically connecting the coil conductor patterns 2a with each other by via hole 2c formed in the insulating sheets 2b.

Ferrite substrates 3 are crimped to coil unit 2 via the adhesive 4 so as to sandwich coil unit 2 from the upper and lower sides and are fixed by the adhesive 4. Adhesive 4 is formed so as to cover the side and bottom of coil unit 2 when it is crimped to the ferrite substrates 3, as shown in FIG. 3.

As shown in FIG. 1, through holes 2d are formed near outside edges of the coil conductor patterns 2a in the insulating sheets 2b of coil unit 2, and the adhesive 4 is injected into the through holes 2d. In this connection, the insulating sheets 2b should be of a size smaller than that of ferrite substrate 3 so as to allow the adhesive 4 to surround the insulating sheets 2b.

Outer electrodes 5 are formed outside ferrite substrates 3 by sputtering, so as to be electrically connected to coil conductor pattern 2a.

Alternatively, chip coil component 10 of the present invention may have a plurality of coil units 2, as shown in FIGS. 4 through 6. In this case, each one insulating sheet may be used for a corresponding coil conductor pattern, or a plurality of coil conductor patterns may be formed on one insulating sheet. Individual configurations of the chip coil component shown in FIGS. 4 to 6 may be the same as in the chip coil component shown in FIGS. 1 through 3, and each configuration has the same reference numeral as in FIGS. 1 through 3, and detailed description is omitted herein.

The present invention will be illustrated in further detail with reference to several examples and comparative examples below, which are not intended to limit the scope of the invention.

### EXAMPLE 1

In a metal vessel with grinding balls, 300 g of a ferrite powder, 0.2 g of a dispersing agent, and 100 g of N-methylpyrrolidone were placed, and the ferrite was pulverized for 2 hours using a sand mill. The resulting ferrite powder had a mean grain size of 0.4 mm. Separately, a polyamic acid (a 20wt % polyamic acid solution) was prepared by allowing pyromellitic anhydride to react with diaminodiphenyl ether in N-methylpyrrolidone, and 200 g of the resulting polyamic acid was put into the metal vessel, and the resulting mixture was mixed and dispersed for further 1 hour to thereby yield an adhesive resin composition.

### EXAMPLE 2

In a metal vessel with grinding balls, 300 g of a ferrite powder, 0.2 g of a dispersing agent, and 100 g of N-methylpyrrolidone were placed, and the ferrite was pulverized for 2 hours using a sand mill. Next, 27 g of bismaleimide resin as a resin having an imide bond and being capable of an addition reaction with an amine, and 13 g of diaminodiphenylmethane were dissolved in 100 g of N-methylpyrrolidone. The N-methylpyrrolidone solution was put into the metal vessel, and the resulting mixture was mixed and dispersed for further 1 hour to thereby yield an adhesive resin composition.

### Comparative Example 1

In a metal vessel with grinding balls, 300 g of a ferrite powder, 0.2 g of a dispersing agent, and 100 g of butylcarbitol were placed, and the ferrite was pulverized for 2 hours using a sand mill. Next, 34.2 g of bisphenol A type epoxy resin having a molecular weight of 900 was dissolved in 100 g of butylcarbitol, and the resulting butylcarbitol solution was put into the metal vessel, and the mixture was mixed and dispersed for further 1 hour, and 4.8 g of a curing agent polyoxypropylenediamine was added to the mixture to thereby yield an adhesive composition.

### Comparative Example 2

A total of 40 g of a thermoplastic polyimide was placed in a dual-axial heating kneader heated at 350° C. and was melted. Subsequently, 40 g of a ferrite powder was put into the kneader and the resulting mixture was kneaded for further 10 minutes to thereby yield an adhesive composition.

### Comparative Example 3

A total of 40 g of a thermoplastic polyimide was placed in a dual-axial heating kneader heated at 350° C. and was melted. A ferrite powder was gradually added to the molten resin and the mixture was kneaded, but the mixture had an excessively high viscosity at time when 60 g of the ferrite powder was added, and the mixture could not be further kneaded to thereby fail to prepare an adhesive composition containing a sufficient amount of ferrite.

### Experimental example

Each 10 mg of the adhesive compositions obtained according to Examples 1 and 2 and Comparative Examples 1 and 2 was weighed in a quartz pan for the determination of thermogravimetric analysis-differential thermal analysis (TG-DTA), and was heated at 100° C. for 2 hours to thereby volatilize the organic solvent, and was then heated and cured in a condition indicated in Table 1. Next, the cured sample was placed in thermogravimetric analyzer-differential thermal analyzer, and a weight reduction temperature was determined by thermogravimetric analysis at a temperature rising rate of 5° C./min. Separately, the ratio of the ferrite powder to the matrix resin ingredient in the adhesive composition was calculated. Additionally, the magnetic permeability of the sample at 100 MHZ was determined with a 27-network analyzer. The results are shown in Table 1.

TABLE 1

| | | 5% Weight | Weight Ratio of | |
|---|---|---|---|---|
| | Curing | Reduction | Ferrite Powder to | Magnetic |
| | Condition | Temperature | Matrix Resin | Permeability |
| Example 1 | 350° C. × | 400° C. | 7.5 | 5 |
| | 0.5 hr | | | |
| Example 2 | 180° C. × | 390° C. | 7.5 | 5 |
| | 1 hr | | | |
| Comp.Ex. 1 | 150° C. × | 250° C. | 7.5 | 5 |
| | 1 hr | | | |
| Comp.Ex. 2 | — | 390° C. | 1 | 2 |

Table 1 shows that the adhesive compositions according to Examples 1 and 2 had a satisfactory heat resistance and that they could contain the ferrite powder 7.5 times by weight or more larger than that of the matrix resin ingredient.

In contrast, the adhesive composition according to Comparative Example 1 had a low heat resistance, although it had a high magnetic permeability due to sufficiently high content of the ferrite powder. The adhesive composition according to Comparative Example 2 had a low magnetic permeability due to an insufficient content of the ferrite powder, although it had a high heat resistance.

As described above, the disclosed adhesive composition can contain a ferrite powder in a high density while using a thermally stable polyimide resin and can therefore form a satisfactorily closed magnetic circuit structure by itself.

Additionally, an adhesive composition having a desired viscosity and magnetic permeability can be obtained by appropriately adjusting the mean grain size and content of the ferrite powder used.

The disclosed method, in which the forced-agitating grinder using a grinding media mixes a ferrite powder with a liquid matrix resin and concurrently grinds the ferrite powder, can greatly shorten the steps of producing an adhesive composition.

Additionally, when a coil is sealed using the disclosed adhesive resin composition, a chip coil component having a closed magnetic circuit structure formed therein can be obtained without the use of an extra magnetic material.

Although the present invention has been described in relation to particular embodiments thereof, many other variations and modifications and other uses will become apparent to those skilled in the art. Therefore, this invention is not to be limited to the specific matters stated above.

What is claimed is:

1. An adhesive resin composition comprising a mixture of a liquid matrix resin and a ferrite powder, said liquid matrix resin containing at least one of the following ingredients (A) and (B):
(A) a polyamic acid; and
(B) a resin having an imide bond, being capable of an addition reaction with an amine or capable of self-polymerization, and being capable of dissolving in an organic solvent.

2. An adhesive resin composition according to claim 1, wherein said liquid matrix resin becomes a polyimide resin after curing.

3. An adhesive resin composition according to claim 1 or claim 2, wherein 200 to 1500 parts by weight of said ferrite powder is contained in said adhesive resin composition relative to 100 parts by weight of a resin ingredient in said liquid matrix resin.

4. An adhesive resin composition according to claim 3, wherein said ferrite powder has a mean grain size from 0.01 mm to 5 mm.

5. An adhesive resin composition according to claim 1 or claim 2, wherein said ferrite powder has a mean grain size from 0.01 mm to 5 mm.

6. A method of producing an adhesive resin composition, comprising the step of mixing a ferrite powder with a liquid matrix resin containing at least one of the following ingredients (A) and (B):
(A) a polyamic acid; and
(B) a resin having an imide bond, being capable of an addition reaction with an amine or capable of self-polymerization, and being capable of dissolving in an organic solvent.

7. A method according to claim 6, wherein said ferrite powder is mixed with said liquid matrix resin while grinding said ferrite powder using a forced-agitating grinder with a grinding media.

8. A chip coil component comprising:
a coil unit having at least one coil conductor pattern;
a pair of magnetic substrates sandwiching said coil unit; and
an outer electrode being electrically connected with said coil conductor pattern,
wherein said coil unit is bonded to said magnetic substrates to thereby allow said magnetic substrates and said adhesive resin composition to form a closed magnetic circuit structure,
said coil unit and magnetic substrates being bonded with an adhesive resin composition comprising a mixture of a liquid matrix resin and a ferrite powder, said liquid matrix resin containing at least one of the following ingredients (A) and (B):
(A) a polyamic acid; and
(B) a resin having an imide bond, being capable of an addition reaction with an amine or capable of self-polymerization, and being capable of dissolving in an organic solvent.

9. A chip coil component according to claim 8, wherein said liquid matrix resin becomes a polyimide resin after curing.

10. A chip coil component according to claim 8 or claim 9, wherein 200 to 1500 parts by weight of said ferrite powder is contained in said adhesive resin composition relative to 100 parts by weight of a resin ingredient in said liquid matrix resin.

11. A chip coil component according to claim 8, further comprising a through hole extending through said coil unit between said pair of magnetic substrates, said through hole containing said adhesive resin composition and thereby forming part of said closed magnetic circuit structure.
